(19) United States
(12) Patent Application Publication
(10) Pub. No.: US 2021/0053608 A1
(43) Pub. Date: Feb. 25, 2021

(54) ASSISTANCE MODULE FOR A POWER STEERING SYSTEM OF A MOTOR VEHICLE, WITH ELIMINATION OF THE RISK OF EJECTION OF A SEPARATION CAGE FROM A MECHANICAL ROLLING BEARING

(71) Applicant: JTEKT EUROPE, Irigny (FR)

(72) Inventor: Mickael GUERIN, Brindas (FR)

(73) Assignee: JTEKT EUROPE, Irigny (FR)

(21) Appl. No.: 16/998,071

(22) Filed: Aug. 20, 2020

(30) Foreign Application Priority Data
Aug. 20, 2019 (FR) 19/09302

(51) Int. Cl. B62D 5/00; F16H 55/24

(52) U.S. Cl. CPC B62D 5/008; F16H 2057/0213; F16H 55/24

(57) ABSTRACT

An assistance module for a power steering system of a motor vehicle, including a reducer casing in which is mounted a reducer including an output shaft provided with a pinion, the output shaft being rotatably mounted inside the reducer casing by means of at least one mechanical rolling bearing carried by a bearing provided on reducer casing between the tangent wheel and pinion, the mechanical rolling bearing having several rolling elements kept at a distance from each other by a separation cage, rolling elements and separation cage being disposed in an annular rolling bearing space formed between a coaxial internal and external ring, the assistance module includes at least one blocking element having at least one stop surface facing the annular rolling bearing space at a distance such that at least one of the stop surfaces prevents an ejection of the separation cage out of the annular rolling bearing space.

The present invention relates to an assistance module for a power steering system of a motor vehicle.

In a conventional manner, a motor vehicle can be provided with a power steering system making it possible to reduce the effort to be provided by the driver thereof to direct it.

Such a power steering system generally comprises a steering module, including a steering rack whose ends are associated, by means of steering tie rods, with the steered wheels of the motor vehicle, and an assistance module, including an assistance motor driving in rotation an output shaft provided with a pinion in engagement with the steering rack of the steering module: it is thus possible to transmit to the steering rack an assistance torque adding to the torque provided by the driver of the motor vehicle on the steering wheel thereof, facilitating its driving.

More specifically, the assistance motor drives a worm screw meshing, in a reducer casing, on a tangent wheel rotationally connected to the output shaft, the output shaft being rotatably mounted inside the reducer casing by means of at least one mechanical rolling bearing carried by a bearing provided on the reducer casing between the tangent wheel and the pinion.

This mechanical rolling bearing usually includes several rolling elements kept at a distance from each other by a separation cage made of a plastic material, clipped onto the rolling elements, these rolling elements and this separation cage being disposed in an annular rolling bearing space formed between an internal ring and a coaxial external ring.

However, in the case of high mechanical stress on the mechanical rolling bearing, for example during a significant misalignment of the output shaft relative to the reducer casing, the separation cage is capable of being ejected, at least partially, out of the annular rolling bearing space.

Such ejection of the separation cage can then lead to a regrouping of the rolling elements of the mechanical rolling bearing in the annular rolling bearing space and then to a sharp reduction, or even to a total loss, of the guiding in rotation of the output shaft relative to the reducer casing.

In order to remedy this problem, it is known to add a flange, disposed between the internal ring and the external ring, on the mechanical rolling bearing, making it possible to physically prevent the ejection of the separation cage.

For example, this flange can be fixed by clipping on the external ring or the internal ring of the mechanical rolling bearing, but this solution requires the creation of a clipping groove on one of the latter.

The addition of such a flange on the mechanical rolling bearing thus involves modifying and making the structure thereof more complex, and therefore represents a significant economic cost.

Another solution is to use a larger mechanical rolling bearing, which can accept a greater load and a misalignment of the output shaft, but this also generates an additional economic cost.

The invention proposes to solve all or part of the aforementioned drawbacks, by proposing a solution which makes it possible to maintain the separation cage of the mechanical rolling bearing in the annular rolling bearing space, without modifying the structure of the mechanical rolling bearing.

Another object of the invention is to propose an inexpensive solution.

To this end, it offers an assistance module for a power steering system of a motor vehicle, including a reducer casing in which is mounted a reducer linked in rotation to an output shaft provided with a pinion, for example a gear reducer including a worm screw driven by an assistance motor and meshing on a tangent wheel linked in rotation to the output shaft, said output shaft being rotatably mounted inside the reducer casing about a longitudinal axis by means of at least one mechanical rolling bearing carried by a bearing provided on the reducer casing between the tangent wheel and the pinion,

said mechanical rolling bearing having several rolling elements kept at a distance from each other by a separation cage, said rolling elements and said separation cage being disposed in an annular rolling bearing space formed between an internal ring and a coaxial external ring,

said separation cage being capable of being ejected from said annular rolling bearing space in an ejection direction,

said assistance module being characterized in that it includes at least one blocking element having at least one stop surface facing the annular rolling bearing space and in the ejection direction, at a distance such as at least one of the stop surfaces prevents said separation cage from being ejected out of the annular rolling bearing space.

Thus, in the case of a significant mechanical stress on the mechanical rolling bearing, the separation cage undergoes possible deformations but cannot be ejected outside the annular rolling bearing space, because the movement of this separation cage in the ejection direction (parallel to the longitudinal axis) is limited by at least one stop surface disposed opposite the annular rolling bearing space.

Thanks to the presence of specific shapes in the reducer casing, in the form of blocking elements whose stop surface(s) limit the movement of the mechanical rolling bearing separation cage, it is possible to (completely or partially) prevent ejecting this separation cage out of the annular rolling bearing space.

The separation cage can therefore continue to fulfill its function of keeping the rolling elements of the mechanical rolling bearing at a distance from each other, even in the case of strong mechanical stress on the mechanical rolling bearing.

It will be noted that the assistance module according to the invention may thus include one or more blocking elements, each having one or more stop surfaces preventing the ejection of the separation cage in various directions.

According to one possibility, the rolling elements are spherical balls and the distance is less than or equal to half of a diameter of these balls.

According to another possibility, the distance is less than or equal to 2 millimeters.

Thus, the stop surface is positioned close enough to the internal ring and the external ring of the mechanical rolling bearing so that the separation cage cannot be ejected out of the annular rolling bearing space therebetween.

In one embodiment, at least one stop surface is positioned, along the longitudinal axis, between the mechanical rolling bearing and the tangent wheel.

Such positioning of a stop surface thus makes it possible to block an ejection of the separation cage in the direction of the tangent wheel.

According to one possibility, at least one stop surface is positioned, along the longitudinal axis, between the mechanical rolling bearing and the pinion.

Such positioning of a stop surface makes it possible to block an ejection of the separation cage in the direction of the pinion (that is to say in a direction opposite to the tangent wheel).

It should be noted that, in practice, it is only necessary to dispose at least one stop surface «on one side» of the mechanical rolling bearing along the longitudinal axis, that is to say to dispose the stop surface(s) either between the mechanical rolling bearing and the pinion, or between the mechanical rolling bearing and the tangent wheel.

Indeed, during the mounting of the mechanical rolling bearing, the separation cage is generally clipped onto the rolling elements and is positioned, inside the annular rolling bearing space, either between the rolling elements and the pinion, or between the rolling elements and the tangent wheel: the separation cage can thus be ejected from the annular rolling bearing space only in one ejection direction, oriented either towards the tangent wheel or towards the pinion.

The ejection direction of the separation cage is thus directed either towards the tangent wheel or towards the pinion, depending on the direction of mounting of the mechanical rolling bearing in the steering casing.

Thus, a single stop surface disposed facing the annular rolling bearing space and on the «right» side of the mechanical rolling bearing (that is to say either between the mechanical rolling bearing and the pinion, or between the mechanical rolling bearing and the tangent wheel, depending on the orientation of the ejection direction) may be sufficient to prevent the ejection of the separation cage.

It is also conceivable to dispose at least one stop surface «on each side» of the mechanical rolling bearing along the longitudinal axis, that is to say between the mechanical rolling bearing and the pinion and between the mechanical rolling bearing and the tangent wheel.

In this way, it is not necessary to know the orientation of the ejection direction of the rolling bearing cage.

According to a possibility, the blocking element is integral with the reducer casing.

It is thus necessary to dispose the blocking element in such a way that once the output shaft and the mechanical rolling bearing mounted in the reducer casing, the stop surface are positioned facing the annular rolling bearing space.

According to a possibility, the blocking element is made in one piece with the reducer casing.

According to another possibility, the blocking element is produced by a foundry method with the reducer casing.

The production of the blocking element by a foundry method thus makes it possible to integrate this blocking element into the reducer casing in an inexpensive manner.

According to yet another possibility, the blocking element is fixed to the reducer casing by screwing, welding or force fitting.

In one embodiment, at least one blocking element is inserted between a shoulder of the reducer casing and the external ring of the mechanical rolling bearing.

For example, the blocking element may take the form of a washer that abuts against the external ring and extends partially opposite the annular rolling bearing space.

In a variant, at least one blocking element is secured to the output shaft.

According to one possibility, the blocking element is made integral with the output shaft.

According to one possibility, the blocking element is made one piece with the output shaft.

According to one characteristic, the blocking element is fixed to the output shaft by screwing, welding or force fitting.

According to another possibility, at least one blocking element is inserted between a shoulder of the output shaft and the internal ring.

For example, the blocking element may take the form of a washer which abuts against the internal ring and extends partially facing the annular rolling bearing space.

In one embodiment, a blocking element is secured to a clamping nut, said clamping nut being screwed inside the bearing between the mechanical rolling bearing and the pinion, and abuts against the external ring.

The primary function of this clamping nut is to block the mechanical rolling bearing in the bearing of the reducer casing: it is possible to modify the structure in order to add to this clamping nut a stop surface facing the annular rolling bearing space.

According to one characteristic, the blocking element is made in one piece with the clamping nut.

According to another characteristic, the blocking element is fixed to the clamping nut by screwing, welding or force fitting.

According to one possibility, at least one blocking element is inserted between the clamping nut and the external ring.

In a variant, a blocking element is secured to a crimping ring, said crimping ring being crimped inside the bearing between the mechanical rolling bearing and the pinion, and abuts against the internal ring.

In the same way as the clamping nut, this crimping ring has the function of blocking the mechanical rolling bearing in the bearing of the reducer casing: it is also possible to modify its structure in order to add to this crimping ring a stop surface facing the annular rolling bearing space.

According to one characteristic, the blocking element is made in one piece with the crimping ring.

According to another characteristic, the blocking element is fixed on the crimping ring by screwing, welding or by force fitting.

According to one possibility, at least one blocking element is inserted between the crimping ring and the internal ring.

For example, the blocking element can thus take the form of a washer which abuts against the crimping ring or the clamping nut and which extends partially facing the annular rolling bearing space.

In one embodiment, at least one blocking element has an annular stop surface, centered on the longitudinal axis.

According to one possibility, at least one blocking element has several distinct stop surfaces, said stop surfaces being arranged about the longitudinal axis.

Thus, the invention enables, with regard to the nature of the at least one blocking element and its positioning relative to the mechanical rolling bearing, a wide variety of embodiments.

Particularly, the blocking element(s) can:
be positioned between the mechanical rolling bearing and the pinion, or between the mechanical rolling bearing and the tangent wheel,
be secured to the steering casing, the output shaft, the clamping nut or the crimping ring, or
consist of an additional element (for example, of the washer type) inserted between the mechanical rolling bearing and the steering casing, the output shaft, the clamping nut or the crimping ring,
have a single annular stop surface or several distinct stop surfaces disposed about the longitudinal axis.

These embodiments can also be combined with one another according to the particular applications, in order even better to guarantee the impossibility of an ejection from the separation cage.

Other characteristics and advantages of the present invention will appear on reading the detailed description below, of an example of non-limiting implementation, made with reference to the appended figures in which:

FIG. 1 is a cross-sectional view of a power steering system of the state of the art;

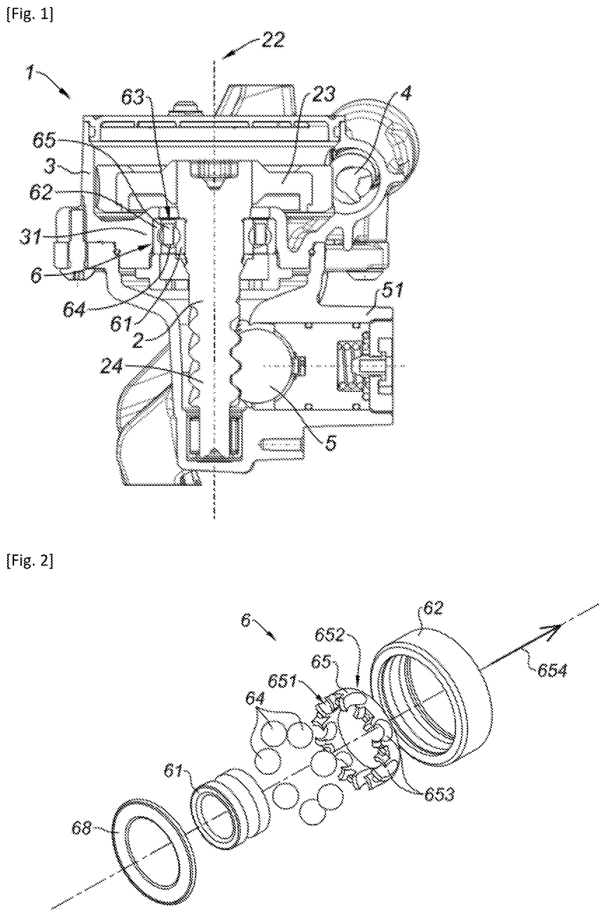

FIG. 2 is an exploded view of a mechanical rolling bearing comprising a separation cage;

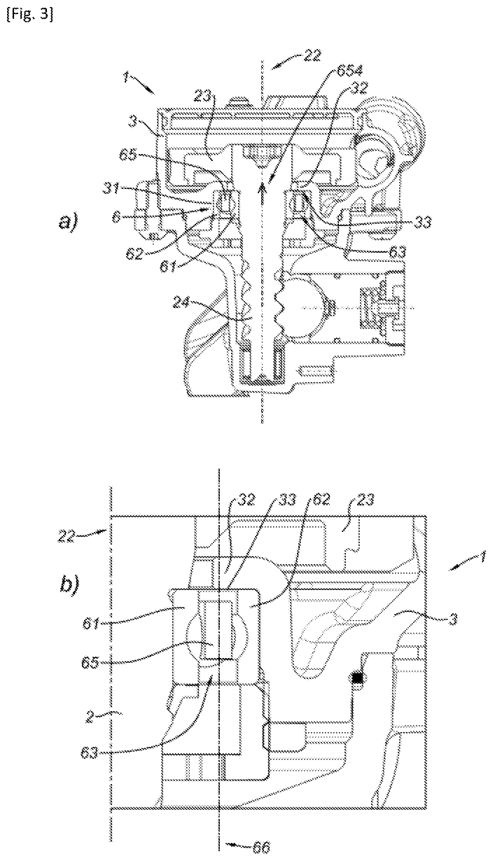

FIG. 3 is a cross-sectional view of a first embodiment of an assistance module according to the invention;

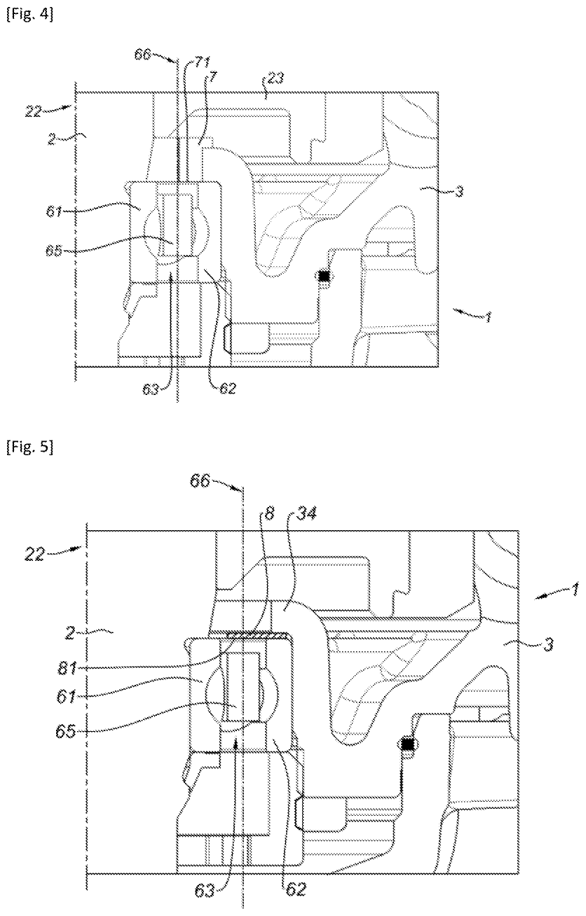

FIG. 4 is a cross-sectional view of a second embodiment of an assistance module according to the invention;

FIG. 5 is a cross-sectional view of a third embodiment of an assistance module according to the invention;

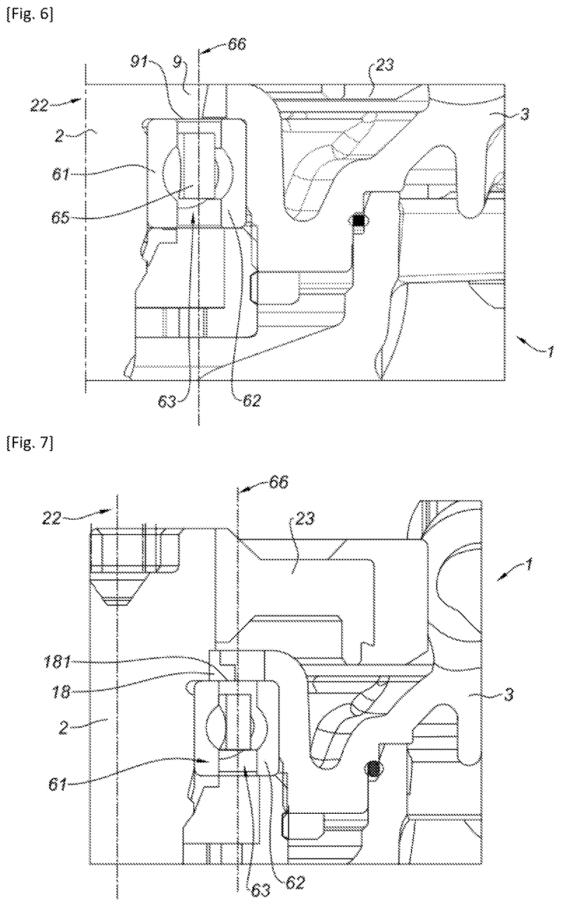

FIG. 6 is a cross-sectional view of a fourth embodiment of an assistance module according to the invention;

FIG. 7 is a cross-sectional view of a fifth embodiment of an assistance module according to the invention;

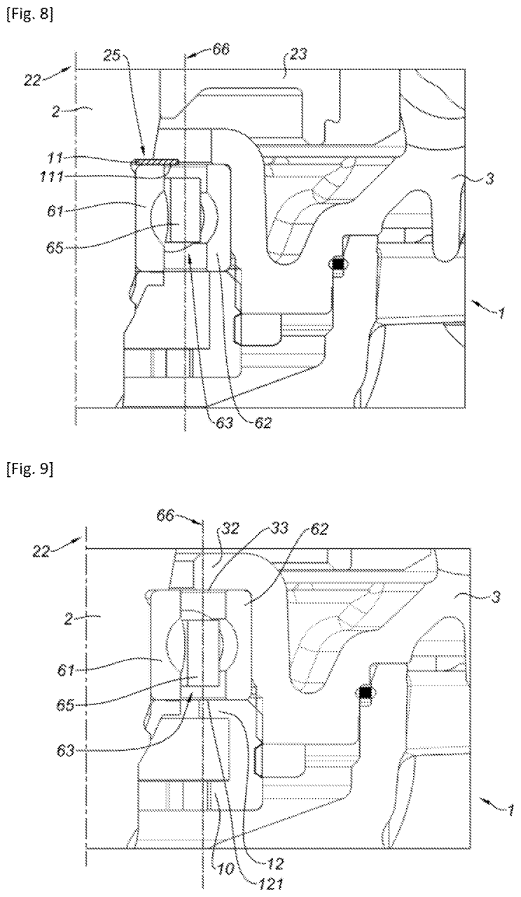

FIG. 8 is a cross-sectional view of a sixth embodiment of an assistance module according to the invention;

FIG. 9 is a cross-sectional view of a seventh embodiment of an assistance module according to the invention;

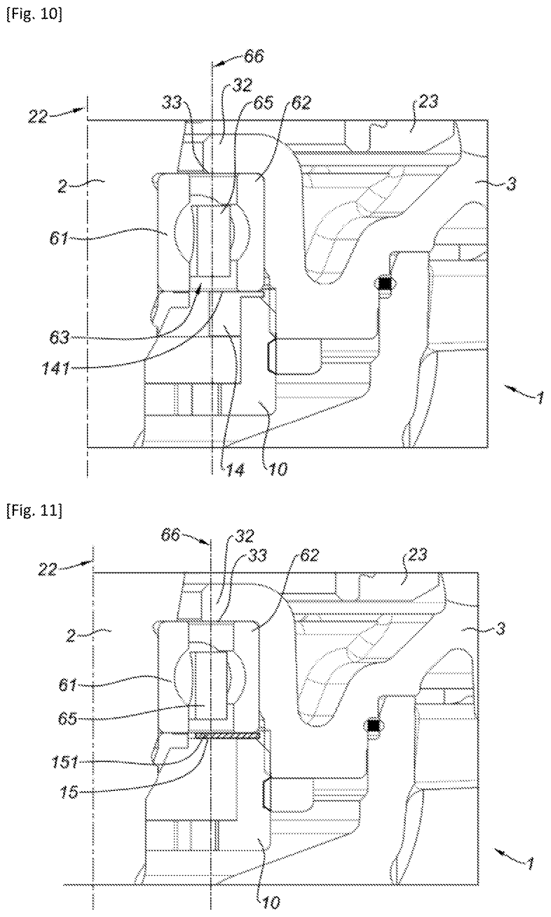

FIG. 10 is a cross-sectional view of an eighth embodiment of an assistance module according to the invention;

FIG. 11 is a cross-sectional view of a ninth embodiment of an assistance module according to the invention;

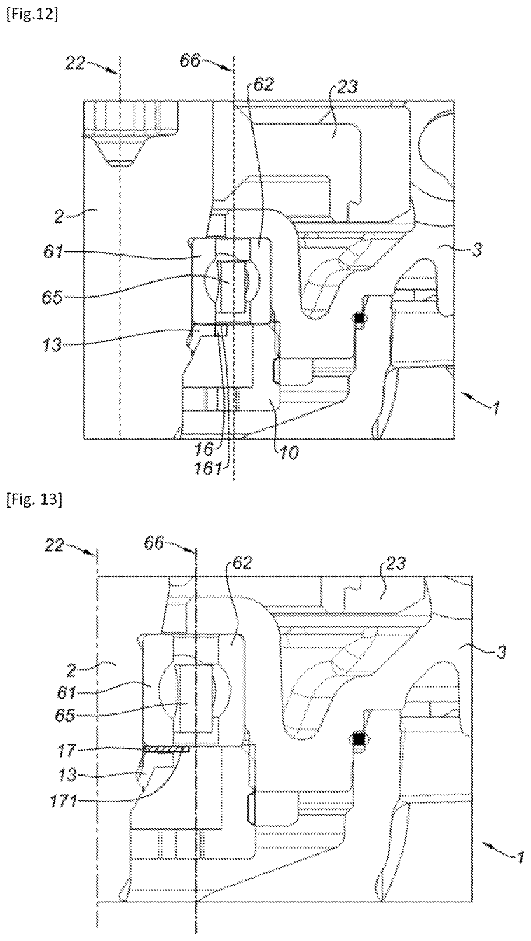

FIG. 12 is a cross-sectional view of a tenth embodiment of an assistance module according to the invention;

FIG. 13 is a cross-sectional view of an eleventh embodiment of an assistance module according to the invention;

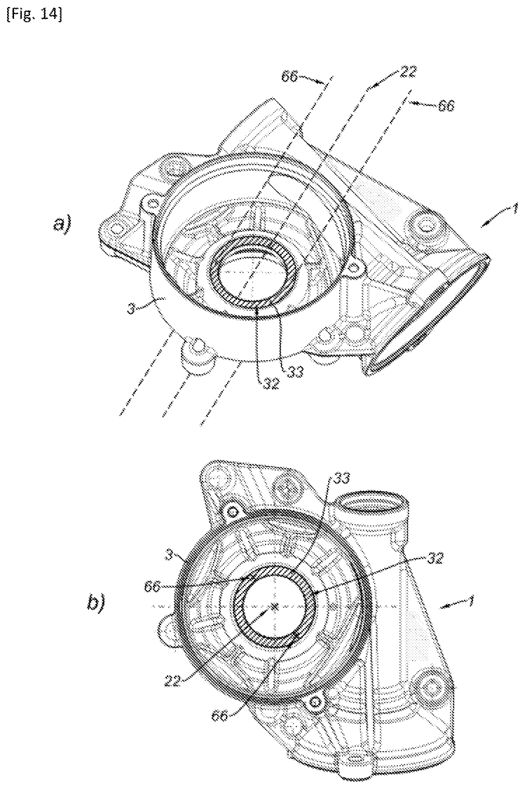

FIG. 14 is a perspective view (FIG. 14a) and a front view (FIG. 14b) of the first embodiment of an assistance module according to the invention;

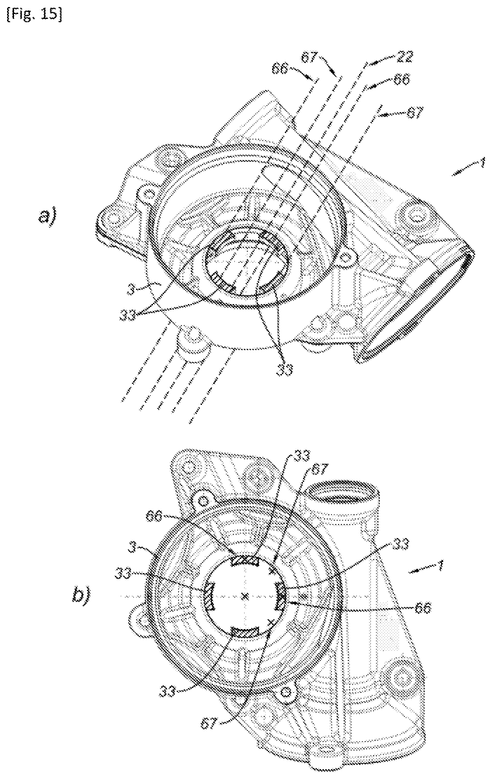

FIG. 15 is a perspective view (FIG. 15a) and a front view (FIG. 15b) of the first embodiment of an assistance module according to the invention.

FIG. 1 represents a power steering system 1 for a motor vehicle of the state of the art.

This power steering system 1 includes in particular an output shaft 2 mounted movable in rotation about a longitudinal axis 22 in a reducer casing 3.

This output shaft 2 is secured to a tangent wheel 23 meshing with a worm screw 4, this worm screw 4 being itself driven in rotation by an assistance motor (not represented).

The output shaft 2 also has a pinion 24 meshing with a rack 5 disposed in a steering casing 51: the rotational movement of the output shaft 2 about the longitudinal axis 22 thus causes a translational movement of the rack 5 in a direction orthogonal to the longitudinal axis 22.

This power steering system 1 thus makes it possible to transmit to the rack 5 a motor torque transmitted to the worm screw 4 by an assistance motor (not represented), in order to facilitate the steering of the electric vehicle by its driver.

Particularly, the output shaft 2 is mounted on the reducer casing 3 via a mechanical rolling bearing 6, disposed in a bearing 31 of the reducer casing 3.

This mechanical rolling bearing 6 is, in this embodiment, formed of an internal ring 61 and an external ring 62 coaxial and centered on the longitudinal axis 22.

The space between this internal ring 61 and this external ring 62 constitutes an annular movement space 63 in which are disposed rolling balls 64.

These rolling balls 64 are kept at a distance from each other by a separation cage 65, also disposed in the annular rolling bearing space 63 of the mechanical rolling bearing 6.

The mechanical rolling bearing 6 thus enables the rotational movement of the output shaft 2 about the longitudinal axis 22 relative to the reducer casing 3.

In this power steering system 1 of the state of the art, it is possible that, following a significant mechanical stress exerted on the mechanical rolling bearing 6 (for example, following a misalignment of the output shaft 2 relative to the longitudinal axis 22), the separation cage 65 undergoes a significant deformation and is ejected out of the annular rolling bearing space 63 in an ejection direction collinear with the longitudinal axis 22.

FIG. 2 represents, in an exploded view, a mechanical rolling bearing 6 including rolling balls 64 disposed between an internal ring 61 and an external ring 62.

This mechanical rolling bearing 6 also includes a protection 68.

The balls 64 are kept at a distance from each other by a separation cage 65.

The separation cage 65 has a front face 651 and an opposite rear face 652 and includes housings 653 formed in the front face 651, each of these housings 651 having a shape adapted to receive a ball 64: the separation cage is thus «clipped» (that is to say, secured by pressure) by its front face with the balls 64.

Due to its particular structure, the housings 653 having an aperture opening only on the front face 651, the separation cage 65 can only be detached from the balls 64 by a movement in an ejection direction 654.

The orientation of this ejection direction 654 thus depends on the direction of mounting of the separation cage 65 in the mechanical rolling bearing 6.

Once the mechanical rolling bearing 6 is positioned in the bearing 31 of the steering casing 51, this ejection direction 654 is collinear with the longitudinal axis 22 and defines the ejection trajectory of the separation cage 65 outside the annular rolling bearing space 63: depending on the mounting direction of the separation cage in the mechanical rolling bearing 6, it will be capable of being ejected either in the direction of the tangent wheel 23, or in the direction of the pinion 24.

Thus, knowing the orientation of this ejection direction 654, it is necessary to dispose a blocking element only on one side of the mechanical rolling bearing 6 along the longitudinal axis 22, that is to say either between the mechanical rolling bearing 6 and the pinion 24, or between the mechanical rolling bearing 6 and the tangent wheel 23.

Embodiments including several blocking elements disposed both between the mechanical rolling bearing 6 and the pinion 24 and between the mechanical rolling bearing 6 and the tangent wheel 23 are also conceivable.

FIG. 3a represents a power steering system 1 according to the invention, FIG. 3b being a detailed view of the bearing 31.

In the embodiment represented in this FIG. 3, the separation cage 65 is capable of being ejected in an ejection direction 654 in the direction of the tangent wheel 23.

The reducer casing 3 includes a blocking element 32 disposed between the tangent wheel 23 and the bearing 31, this blocking element 32 having a stop surface 33 extending facing the annular rolling bearing space 63 of the mechanical rolling bearing 6.

Particularly, this stop surface 33 is positioned perpendicular to an ejection axis 66 materializing the trajectory of the separation cage 65 in the ejection direction 654.

The stop surface 33 intersects this ejection axis 66 near the ball rolling bearing 6: in this way, the stop surface 33 physically prevents a movement of the separation cage 65 along the ejection axis 66 and in the direction of the tangent wheel 23.

Thus, this blocking element 32 makes it possible to prevent (at least partially) the ejection of the separation cage 65 out of the annular rolling bearing space 63 in the direction of the tangent wheel 23.

In this embodiment, the blocking element is made in one piece with the reducer casing 3, and was produced by a foundry method with this reducer casing 3.

Obviously, many other embodiments of the invention can be envisaged, particularly concerning the shape of the blocking element 32 and its stop surface 33, and the placement of these relative to the mechanical rolling bearing 6 and to the annular rolling bearing space 63.

FIG. 4 represents an alternative embodiment of the invention, in which a blocking element 7, external to the reducer casing 3, is fixed on the latter by screwing or welding, or even by force fitting.

This blocking element 7 has a stop surface 71, disposed perpendicular to the ejection axis 66 and facing the annular rolling bearing space 63 of the mechanical rolling bearing 6.

In this way, this blocking element 7 makes it possible to prevent an ejection of the separation cage 65 from the annular rolling bearing space 63, along the ejection axis 66 and in the direction of the tangent wheel 23.

FIG. 5 represents a third embodiment of the invention, in which the blocking element is formed by a washer 8 inserted between the external ring 62 of the mechanical rolling bearing 6 and a shoulder 34 of the reducer casing 3.

This washer 8 is thus positioned in abutment against the external ring 62, between the mechanical rolling bearing 6 and the tangent wheel 23, and has a stop surface 81 extending facing the annular rolling bearing space 63, perpendicular to the ejection axis 66.

As previously, the presence of this washer 8 thus makes it possible to physically prevent the ejection of the separation cage 65 out of the annular rolling bearing space 63, in the direction of the tangent wheel 23.

For example, it is conceivable that the washer 8 is made of a material of the metallic or plastic type.

It will be noted that it is possible to combine the various embodiments previously described, for example by associating the use of a washer 8 (external to the reducer casing 3) as represented in FIG. 5 with a blocking element 32 (secured to the reducer casing 3) as represented in FIG. 3, this blocking element 32 is made in one piece with the shoulder 34.

The following FIGS. 6 to 8 respectively represent a fourth, a fifth and a sixth embodiment of the invention, in which a blocking element is secured to the output shaft 2 and adapted to prevent, as previously, an ejection of the separation cage 65 in the direction of the tangent wheel 23.

Particularly, in the fourth embodiment of the invention described in FIG. 6, the power steering system 1 has a blocking element 9 made in one piece with the output shaft 2.

This blocking element 9 has a stop surface 91 extending facing the annular rolling bearing space 63 and perpendicularly intersecting the ejection axis 66: the blocking element 9 thus makes it possible in this way to prevent an ejection movement of the separation cage 65 out of the annular rolling space 63, along the ejection axis 66 and in the direction of the tangent wheel 23.

It should be noted that, this blocking element 9 being secured to the output shaft 2, it is also driven in the rotational movement of the latter about the longitudinal axis 22.

Similarly, in the fifth embodiment described in FIG. 7, the blocking element 9 made in one piece with the output shaft 2 is replaced by a blocking element 18, external to the output shaft 2 and secured to the latter by screwing, welding or force fitting.

This blocking element 18 has a stop surface 181 intersecting the ejection axis 66 and thus making it possible to prevent an ejection of the separation cage 65 from the annular rolling bearing space 63, in the direction of the tangent wheel 23.

FIG. 8 represents a sixth embodiment of the invention, in which the blocking element takes the form of a washer 11, positioned between a shoulder 25 of the output shaft 2 and the internal ring 61 of the mechanical rolling bearing 6, and has a stop surface 111 extending opposite the annular rolling bearing space 63, perpendicular to the ejection axis 66.

This washer 11 therefore makes it possible in this way to prevent an ejection movement of the separation cage 65 out of the annular rolling bearing space 63, along the ejection axis 66 and in the direction of the tangent wheel 23.

The following FIGS. 9 to 13 illustrate embodiments of the invention, in which a suitable blocking element makes it possible to prevent an ejection of the separation cage 65 from the annular rolling bearing space 63 in the direction of the pinion 24, that is to say in an ejection direction opposite to that of the embodiments previously described by FIGS. 1 to 7.

Particularly, the following FIGS. 9, 10 and 11 respectively represent a seventh, an eighth and a ninth embodiment of the invention, in which a blocking element is secured to a clamping nut 10, while the following FIGS. 12 and 13 respectively represent a tenth and an eleventh embodiment of the invention, in which a blocking element is secured to a crimping ring 13.

With reference to FIG. 9, the steering system 1 includes a blocking element 12 made in one piece with a clamping nut 10, screwed inside the bearing 31 of the reducer casing 3 between the mechanical rolling bearing 6 and the pinion 24, in abutment against this same mechanical rolling bearing 6.

The function of this clamping nut 10 is to keep the mechanical rolling bearing 6 in position in the bearing 31 of the reducer casing 3.

In the embodiment represented by FIG. 9, the blocking element 12 made in one piece with the clamping nut 10 has a stop surface 121 extending facing the annular rolling bearing space 63 perpendicular to the ejection axis 66.

Thus, the stop surface 121 makes it possible to physically block an ejection movement of the separation cage 65 out of the annular rolling bearing space 63, in the direction of the pinion 24.

Similarly, in the embodiment described in FIG. 10, the blocking element 12 made in one piece with the clamping nut 10 is replaced by a blocking element 14, external to the clamping nut 10 and secured to the latter by screwing, welding or force fitting.

This blocking element 14 has a stop surface 141 intersecting the ejection axis 66 and thus making it possible to prevent an ejection of the separation cage 65 out of the annular rolling bearing space 63, in the direction of the pinion 24.

In the embodiment represented by FIG. 11, the blocking element takes the form of a washer 15, positioned between the clamping nut 10 and the external ring 62 of the mechanical rolling bearing 6, and has a stop surface 151 extending facing the annular rolling bearing space 63, perpendicular to the ejection axis 66.

This washer 15 therefore makes it possible in this way to prevent an ejection movement of the separation cage 65 out of the annular rolling bearing space 63, along the ejection axis 66 and in the direction of the pinion 24.

It will also be noted, in these FIGS. 9 to 11, the presence of the blocking element 32 secured to the reducer casing 3, whose stop surface 33 prevents (as previously described) an ejection movement of the separation cage 65 in the opposite direction, namely in the direction of the tangent wheel 23.

FIG. 12 represents a tenth embodiment of the invention, in which a blocking element 16 is made in one piece with a crimping ring 13.

This crimping ring 13 has the function, similar to the clamping nut 10, of holding the mechanical rolling bearing 6 in position in the bearing 31 of the reducer casing 3, and is usually positioned between the mechanical rolling bearing 6 and the pinion 24, in abutment against the internal ring 61.

This blocking element 16 has a stop surface 161 intersecting the ejection axis 66 and thus making it possible to prevent an ejection of the separation cage 65 out of the annular rolling bearing space 63, in the direction of the pinion 24.

Alternatively, in the embodiment represented by FIG. 13, the blocking element takes the form of a washer 17 positioned between the crimping ring 13 and the internal ring 61 of the mechanical rolling bearing 6, and has a stop surface 171 extending opposite the annular rolling bearing space 63, perpendicular to the ejection axis 66.

This washer 17 thus makes it possible in this way to prevent an ejection movement of the separation cage 65 from the annular rolling bearing space 63, along the ejection axis 66 and in the direction of the pinion 24.

It should be noted that, for each of the embodiments previously described and represented by the preceding FIGS. 2 to 13 in transverse view, it is conceivable that the stop surface of each considered blocking element has an annular shape, centered on the longitudinal axis 22.

For example, FIGS. 14a and 14b are respectively representations of the embodiment described by the preceding FIG. 3 in perspective and in front view (along the longitudinal axis 22).

In these figures, the stop surface 33 of the blocking element 32 made in one piece with the reducer casing 3 has an annular shape «surrounding» the output shaft 22 and centered on the longitudinal axis 22: this stop surface 32 thus extends over the entire periphery of the external ring 62 and thus prevents any movement of ejection of the separation cage 65 out of the annular rolling bearing space 63 of the mechanical rolling bearing 6 along any ejection axis facing the annular rolling bearing space 63 and parallel to the longitudinal axis 22, in the direction of the tangent wheel 23.

Conversely, it is also conceivable that the considered blocking element in each of the embodiments of the preceding FIGS. 2 to 13 has several distinct stop surfaces, these distinct stop surfaces being disposed about the longitudinal axis 22.

For example, FIGS. 15a and 15b are respectively representations of the embodiment described by the previous FIG. 3 in perspective and in front view (along the longitudinal axis 22).

In this FIG. 15, the blocking element 32 (secured to the reducer casing 3) has four stop surfaces 33 disposed about the output shaft 2 and equidistant from the longitudinal axis 22.

In this configuration, the stop surfaces 33 of the blocking element 32 prevent an ejection movement of the separation cage 65 from the annular rolling bearing space 63 along several ejection axes 66 facing which are disposed stop surfaces 33.

However, the ejection movements of the separation cage 65 along the ejection axes 67 positioned between these stop surfaces 33 (and therefore facing none of them) are left free.

Due to the rigidity and the size of the separation cage 65, it is however very improbable that it can be entirely ejected out of the annular rolling bearing space 63 of the mechanical rolling bearing 6 in an interval separating two stop surfaces 33: if a portion of the separation cage 65 should be ejected along an ejection axis 67 (facing no stop surface 33) other adjacent portions of this same separation cage 65 would be ejected according to ejection axes 66 (facing at least one stop surface 33) would then come into contact with one or more stop surfaces 33.

Thus, the total ejection of the ejection cage 65 from the annular rolling bearing space 63 is prevented by the stop surfaces 33, even when the latter do not extend over the entire periphery of the mechanical rolling bearing 6.

The latter solution has the advantage of ensuring good guiding of the output shaft in the reducer casing 3 thanks to the presence of a blocking element having weaker area and therefore less costly stop surfaces.

1. An assistance module for a power steering system 1 of a motor vehicle, including a reducer casing in which is mounted a reducer comprising an output shaft provided with a pinion, said output shaft being rotatably mounted inside the reducer casing about a longitudinal axis by means of at least one mechanical rolling bearing carried by a bearing provided on the reducer casing between the tangent wheel and the pinion,
said mechanical rolling bearing having several rolling elements kept at a distance from each other by a separation cage, said rolling elements and said separation cage being disposed in an annular rolling bearing space formed between a coaxial internal ring and external ring,
said separation cage being capable of being ejected out of said annular rolling bearing space in an ejection direction,
said assistance module being wherein it comprises at least one blocking element having at least one stop surface facing the annular rolling bearing space and in the ejection direction, at a distance such that at least one of the stop surfaces prevents an ejection of said separation cage out of the annular rolling bearing space.

2. The assistance module according to claim 1, wherein the rolling elements are balls of spherical shape and wherein the distance is less than or equal to half of a diameter of said balls.

3. The assistance module according to claim 2, wherein the distance is less than or equal to 2 millimeters.

4. The assistance module according to claim 3, wherein at least one stop surface is positioned, along the longitudinal axis, between the mechanical rolling bearing and the tangent wheel.

5. The assistance module according to claim 1, in which at least one stop surface is positioned, along the longitudinal axis, between the mechanical rolling bearing and the pinion.

6. The assistance module according to claim 1, wherein at least one blocking element is secured to the reducer casing.

7. The assistance module according to claim, wherein the blocking element is made in one piece with the reducer casing.

8. The assistance module according to claim 7, wherein the blocking element is produced by a foundry method with the reducer casing.

9. The assistance module according to claim 4, wherein the blocking element is fixed to the reducer casing by screwing, welding or force fitting.

10. The assistance module according to claim 1, wherein at least one blocking element is inserted between a shoulder of the reducer casing and the external ring of the mechanical rolling bearing.

11. The assistance module according to claim 1, wherein at least one blocking element is secured to the output shaft.

12. The assistance module according to claim 11, wherein the blocking element is made in one piece with the output shaft.

13. The assistance module according to claim 11, wherein the blocking element is fixed to the output shaft by screwing, welding or force fitting.

14. The assistance module according to claim 1, wherein at least one blocking element is inserted between a shoulder of the output shaft and the internal ring.

15. The assistance module according to claim 1, wherein a blocking element is secured to a clamping nut nut, said clamping nut being screwed inside the bearing between the mechanical rolling bearing and the pinion, and abuts against the external ring.

16. The assistance module according to claim 15, wherein the blocking element is made in one piece with the clamping nut.

17. The assistance module according to claim 15, wherein the blocking element is fixed to the clamping nut by screwing, welding or force fitting.

18. The assistance module according to claim 1, wherein at least one blocking element is inserted between the clamping nut and the external ring.

19. The assistance module according to claim 1, wherein a blocking element is secured to a crimping ring, said crimping ring being crimped inside the bearing between the mechanical rolling bearing and the pinion, and abuts against the internal ring.

20. The assistance module according to claim 19, wherein the blocking element is made in one piece with the crimping ring.

21. The assistance module according to claim 1, wherein at least one blocking element is inserted between the crimping ring and the internal ring.

22. The assistance module according to claim 1, wherein at least one blocking element has a stop surface of an annular shape, centered on the longitudinal axis.

23. The assistance module according to claim 1, wherein at least one blocking element has several distinct stop surfaces, said stop surfaces being disposed about the longitudinal axis.
